(19) United States
(12) Patent Application Publication
(10) Pub. No.: US 2026/0327086 A1
(43) Pub. Date: Oct. 22, 2026

(54) A PROCESS FOR RECOVERING POTASSIUM SULPHATE

(71) Applicant: Reward Minerals Limited, Nedlands (AU)

(72) Inventors: Michael Ruane, Nedlands (AU); Warren Hinchliffe, Nedlands (AU)

(73) Assignee: Reward Minerals Limited, Nedlands (AU)

(21) Appl. No.: 19/101,437

(22) PCT Filed: Aug. 9, 2023
(86) PCT No.: PCT/AU2023/050747

§ 371 Date: Feb. 5, 2025

(30) Foreign Application Priority Data
Aug. 11, 2022 (AU) 2022902277

(51) Int. Cl. C01D 5/00; C01F 11/00; C05D 1/02

(52) U.S. Cl. CPC C01D 5/00; C01F 11/00; C05D 1/02; C01P 2006/80

(57) ABSTRACT

A process for recovering syngenite from a brine having a higher magnesium (Mg) concentration (w/v) than potassium (K) concentration (w/v) is disclosed. The process includes the steps of a) concentrating said brine to obtain a first concentrated liquor having a K concentration approaching saturation, mixing with K depleted liquor from the syngenite precipitation reaction and allowing the combined liquor to further concentrate and separate into crystallised solids and a Mg-rich supernatant liquor. The Mg-rich supernatant liquor is then decanted and the crystallised solids are redissolved in water to obtain a second concentrated liquor comprising greater than 40 g/L K and a relative Mg to K concentration (w/v) of less than or equal to 1:1. The second concentrated liquor is then reacted with a less than stoichiometric amount of gypsum at less than 40° C. to produce syngenite and a potassium-depleted solution. The syngenite is separated according to conventional techniques. Potassium sulphate may be subsequently recovered by leaching the separated syngenite with water to produce gypsum and a potassium sulphate-enriched solution. The gypsum is separated and optionally recycled for reuse upstream and the potassium sulphate-enriched solution is evaporated to produce high grade potassium sulphate product.

### TECHNICAL FIELD

The present disclosure relates to a process for recovering potassium sulphate from brines, in particular brines having a higher magnesium concentration (w/v) than a potassium concentration (w/v).

### BACKGROUND

The following discussion of the background to the invention is intended to facilitate an understanding of the invention. However, it should be appreciated that the discussion is not an acknowledgement or admission that any of the material referred to was published, known or part of the common general knowledge as at the priority date of the application.

Potassium sulphate, also known as sulphate of potash, is a water soluble salt having the formula K₂SO₄. The primary use of potassium sulphate is as a fertilizer, providing both potassium and sulphur nutrients.

Potassium sulphate can be produced via numerous processes from sylvite, schoenite, glaserite, kainite and carnallite salts which can be crystallised from naturally occurring brines. Sulphate of potash can also be prepared by treatment of potassium chloride with sulphuric acid (Mannheim Process).

In another process, potassium sulphate can be produced from the mineral polyhalite (K₂SO₄·MgSO₄·2CaSO₄·2H₂O) whereby the calcined (600° C.) polyhalite is leached with hot water to produce a solution of K₂SO₄+MgSO₄ the solid product syngenite (K₂SO₄·CaSO₄·H₂O). The syngenite is further leached with hot water (90° C.+) to form a potassium sulphate solution and a solid phase of pentasalt (K₂SO₄·5CaSO₄·H₂O). The recovery of potassium sulphate from the pentasalt residue may be achieved by a slow leach with water at ambient temperatures to yield a solution of approximately 30 g/L potassium sulphate. The recovery of potassium sulphate from the resultant solutions requires separation of K₂SO₄ from a mixed K₂SO₄ and MgSO₄ solution and evaporation of dilute K₂SO₄ solutions.

U.S. Pat. No. 3,348,913 describes a process for extracting potassium sulphate from a brine resulting from the processing of kainite ore. Gypsum is added to the brine to produce syngenite but only low potassium recoveries are achieved unless the potassium and sulphate values of the brine chemistry are increased by addition of high value schoenite (K₂SO₄·MgSO₄·H₂O) or a schoenite solution (excluding chloride), thereby increasing the relative concentrations of both potassium and magnesium with respect to chloride in the brine. Even with addition of schoenite, the recovery of potassium from the kainite brine is about 33% at most. Furthermore, the reaction time to produce syngenite is reportedly slow, proceeding over 8-10 hours.

U.S. Pat. No. 2,804,371 describes the removal of sulphate values from waste brines derived from typical sylvite (mining) potash operations by the addition of gypsum to form solid syngenite. The feed brine referred to in U.S. Pat. No. 2,804,371 was low in magnesium and sulphate and not typical of the high magnesium and sulphate brines derived from seawater and many inland salinas globally.

Generally, the processes referred to in U.S. Pat. No. 2,804,371 are multi-staged and rely on considerable thermal energy input. Furthermore, the potassium recoveries are low with a significant portion of the potassium lost to waste.

The process as described herein seeks to alleviate some of the aforementioned problems.

### SUMMARY

The processes as described herein may be used to produce syngenite and/or potassium sulphate from brines, in particular brines having a higher magnesium concentration (w/v) than potassium concentration (w/v).

One aspect of the disclosure provides a process for producing syngenite from a brine, the process comprising the steps of:
a) concentrating said brine to obtain a first concentrated liquor having a K concentration approaching saturation and allowing the first concentrated liquor to further concentrate and separate as crystallised solids and a Mg-rich supernatant liquor;
b) decanting the Mg-rich supernatant liquor;
c) dissolving the crystallised solids in water to obtain a second concentrated liquor comprising greater than 40 g/L K and a relative Mg to K concentration (w/v) of less than or equal to 1:1; and
d) reacting the second concentrated liquor with less than a stoichiometric amount of gypsum at less than 40° C. to produce syngenite and a potassium-depleted solution, and separating syngenite from the potassium-depleted solution.

Another aspect of the disclosure provides a process for recovering potassium sulphate from a brine, the process comprising the steps of:
a) concentrating said brine to obtain a first concentrated liquor having a K concentration approaching saturation and allowing the first concentrated liquor to further concentrate and separate as crystallised solids and a Mg-rich supernatant liquor;
b) decanting the Mg-rich supernatant liquor;
c) dissolving the crystallised solids in water to obtain a second concentrated liquor comprising greater than 40 g/L K and a relative Mg to K concentration (w/v) of less than or equal to 1:1;
d) reacting the second concentrated liquor with less than stoichiometric amount of gypsum at less than 40° C. to produce syngenite and a potassium-depleted solution, and separating syngenite from the potassium-depleted solution;
e) leaching the separated syngenite with water to produce gypsum and a potassium sulphate-enriched solution, and separating the gypsum from the potassium sulphate-enriched solution;
f) concentrating the potassium sulphate-enriched solution to a concentration sufficient for potassium sulphate to crystallise from said concentrated solution, and separating the crystallised potassium sulphate therefrom.

The inventors have discovered that syngenite yield is primarily determined by K concentration and the relative concentration of Mg and K. In particular, a K concentration of greater than 40 g/L is required to achieve K first pass recovery in the form of syngenite of greater than 35%. For example, for seawater-based brines that are evaporated to K saturation (29.9 g/L K) and then reacted with stoichiometric amounts of gypsum (relative to K₂SO₄), the recovery of K to syngenite at ambient temperature is very low, well below 10%. The low K saturation concentration in seawater brine is a function of the high NaCl and MgCl₂ content, in particular MgCl₂. To obtain a brine with greater than 40 g/L K, it is necessary to deplete the brine of MgCl₂, as proposed according to the process as described herein. The brine is concentrated to the point of K saturation to allow crystallisation of mixed K—Mg salts, whereupon the Mg-rich brine is decanted to deplete Mg content, and the remaining mixed K—Mg salts are redissolved in water to obtain a concentrated liquor having a K concentration of greater than 40 g/L and a relative Mg to K concentration (w/v) of less than or equal to 1:1. Said concentrated liquor may then be reacted with a less than stoichiometric amount of gypsum to produce syngenite at good yield. In this way, the process as described herein is suited to recover syngenite and potassium sulphate from potassium-containing brines from a wide range of sources, regardless of the magnesium and sodium content, without the need to augment the brine with additional sources of potassium as taught in prior art processes.

It will be appreciated by those skilled in the art that the K concentration at saturation will vary according to ambient temperature, pressure and humidity and the composition of the brine, in particular the Mg concentration. For example, evaporated seawater may comprise from 90 g/L to 120 g/L Mg and the K concentration approaching saturation is about 30 g/L K. On the other hand, for brines having a lower magnesium content (e.g., 6 g/L) the K concentration approaching saturation may be considerably higher e.g., 40-50 g/L.

In one embodiment, the first concentrated liquor may be mixed with K depleted liquor from step d) and the resulting combined stream may be allowed to further concentrate in a separate evaporation pond to generate crystallised solids and a Mg-rich supernatant liquor.

In one embodiment, the Mg-rich supernatant liquor comprises >100 g/L Mg and <5-8 g/L K.

In one embodiment, the Mg-rich supernatant liquor is decanted to waste leaving the crystallised solids in situ.

In one embodiment, the crystallised solids are potassium-enriched. It will be appreciated that the crystallised solids may contain magnesium and sodium, depending on the composition of the brine.

In one embodiment, the crystallised solids in step c) are dissolved in low TDS aqueous solution.

In one embodiment, the less than stoichiometric amount of gypsum comprises from about 75% to about 90% stoichiometric amount of gypsum.

In one embodiment, the process further comprises combining the separated potassium-depleted solution obtained in step d) with the brine in step a). When combined, the ratio of K:Mg in the combined streams may be about 1:2.5.

In another embodiment, the process further comprises recycling gypsum produced and separated in step e) for use in step d).

In one embodiment, leaching the separated syngenite with water comprises contacting the syngenite with water at a temperature of 60° C. to 70° C. for about 4 h. The syngenite may be in the form of a wet filter cake having an entrained liquor content in a range of 30-45 wt %. The wet syngenite may be mixed with water in a ratio of about 1:3 to about 1:5 w/w.

In one embodiment the potassium sulphate-enriched solution comprises about 50 g/L potassium sulphate.

In one embodiment the separated crystallised potassium sulphate has a purity of >96%.

In another embodiment, a yield of crystallised potassium sulphate with respect to the second concentrated liquor is greater than 75%, in particular greater than 80%.

### BRIEF DESCRIPTION OF DRAWING

Preferred embodiments will now be further described and illustrated, by way of example only, with reference to the accompanying drawing in which:

FIG. 1 is a process flowsheet of one embodiment of a process for recovering potassium sulphate from brines as disclosed herein.

### DESCRIPTION OF EMBODIMENTS

The present disclosure relates to a process for recovering potassium sulphate from brines, in particular brines having a higher magnesium concentration (w/v) than a potassium concentration (w/v).

### General Terms

Throughout this specification, unless specifically stated otherwise or the context requires otherwise, reference to a single step, composition of matter, group of steps or group of compositions of matter shall be taken to encompass one and a plurality (i.e. one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

Each example of the present disclosure described herein is to be applied mutatis mutandis to each and every other example unless specifically stated otherwise. The present disclosure is not to be limited in scope by the specific examples described herein, which are intended for the purpose of exemplification only. Functionally-equivalent products, compositions and methods are clearly within the scope of the disclosure as described herein.

The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.).

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Reference to positional descriptions, such as lower and upper, are to be taken in context of the embodiments depicted in the figures, and are not to be taken as limiting the invention to the literal interpretation of the term but rather as would be understood by the skilled addressee.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The term “and/or”, e.g., “X and/or Y” shall be understood to mean either “X and Y” or “X or Y” and shall be taken to provide explicit support for both meanings or for either meaning.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the present specification, including definitions, will control. In addition, the materials, methods, and examples are illustrative only and not intended to be limiting.

The term “about” as used herein means within 5%, and more preferably within 1%, of a given value or range. For example, “about 3.7%” means from 3.5 to 3.9%, preferably from 3.66 to 3.74%. When the term “about” is associated with a range of values, e.g., “about X % to Y %”, the term “about” is intended to modify both the lower (X) and upper (Y) values of the recited range. For example, “about 20% to 40%” is equivalent to “about 20% to about 40%”.

### Specific Terms

The term “bitterns” as used herein refers to a concentrated salt solution formed when halite (NaCl) precipitates from seawater brines, or brines from salt lakes. The concentrated salt solution may have a specific gravity greater than 1.25, and may contain magnesium, calcium and potassium cations, as well as chloride, sulphate, iodide, bromide and other anions. It will be appreciated that bitterns is a specific type of brine as defined above.

The term “brine” as used herein refers to a concentrated salt solution having a concentration of from about 3.5% w/v to about 26% w/v of sodium chloride and other water-soluble alkali metal and alkaline earth metal salts such as potassium, magnesium and calcium. Brines include, but are not limited to, seawater, those formed naturally due to evaporation of saline groundwater, those generated in mine dewatering activities, or waters discarded from sea water desalination plants.

The term “depleted” means having a lesser mole % concentration of the indicated component than the original stream from which it was formed.

The term “enriched” means having a greater mole % concentration of the indicated component than the original stream from which it was formed.

The term “stoichiometric” as used herein refers to the mole fraction (%) of gypsum (solid and/or recycled) added relative to the amount of gypsum required for the formation of syngenite from gypsum (solid) and K₂SO₄ present in the second concentrated potassium liquor. For example, 75% stoichiometric would mean 0.75 moles CaSO₄·2H₂O (solid) per 1.0 mole of K₂SO₄ in the second concentrated potassium liquor.

The term ‘syngenite’ as used herein refers to a mixed potassium calcium sulphate salt having the chemical formula K₂SO₄·CaSO₄·H₂O.

The term ‘TDS’ as used herein refers to total dissolved solids. A reference to ‘low TDS’ means an aqueous solution comprising 35000 mg/L or less of total dissolved solids.

### Process for Recovering Potassium Sulphate

Potassium sulphate and syngenite may be recovered according to the process disclosed herein from brines, in particular brines having a higher magnesium concentration (w/v) than a potassium concentration (w/v). The brines may be from various sources including, but not limited to, evaporative sodium chloride production from seawater, evaporation of concentrate streams from desalination, salt lake brines, bitterns and so forth.

### Concentrating the Brine

In one embodiment, the brine may comprise sea water bitterns comprising 9.8 g/L K, 32.8 g/L Mg and 46.1 g/L SO₄ which commences crystallisation of K salts upon evaporation to a concentration of about 30 g/L K and 90 g/L Mg.

In another embodiment, the brine may comprise a lake brine comprising 6.2 g/L K, 5.8 g/L Mg and 28.7 g/L SO₄, which upon evaporation commences crystallisation of K salts at a concentration of about 40 g/L K and 38 g/L Mg.

The brine may have a specific gravity in a range of 1.20 to 1.35.

The brine may be concentrated to obtain a first concentrated liquor having a K concentration approaching saturation. It will be appreciated by those skilled in the art that the K concentration approaching saturation may vary according to the composition of the brine, in particular the Mg, Na, CI and SO₄ concentrations. The saturation point of K for brines with varying brine compositions may be determined by reference to “Solution balances of the systems of the salts of oceanic salt deposits” by J. D'Ans, XXXI Schedules, Kali-Forschungs-Anstalt Ges.m.b.h (Berlin, 1933).

The first concentrated liquor may be obtained by evaporating the feed brine in one or more evaporation ponds to deposit NaCl and MgSO₄ salts. The number of evaporation ponds (or concentration stages) will vary according to the initial concentration of the brine, its composition, the surface area and depth of the evaporation ponds, and the ambient temperature and climatic conditions.

Alternatively, the first concentrated liquor may be obtained by other well understood conventional mechanical techniques such as pumping from lake bed trenches or sub-surface aquifers.

The first concentrated liquor is allowed to precipitate crystalline potassium enriched solids and a Mg-rich supernatant liquor which is removed by decantation, leaving the solids in situ in the evaporation pond.

As will be described later, the first concentration liquor may alternatively be mixed with potassium depleted liquor arising from production of syngenite, whereby the resulting combined stream may be allowed to further concentrate in a separate evaporation pond and allowed to separate into crystallised solids and a Mg-rich supernatant liquid.

The Mg-rich supernatant liquor may comprise 5-8 g/L K and >100 g/L Mg and can be directed to waste. Although a small amount of potassium is lost in the Mg-rich supernatant liquor, the separation of the Mg-rich supernatant liquor advantageously depletes the subsequent second concentrated liquor stream (which is produced by dissolving the potassium-enriched solids in water, as will be described later) of residual magnesium and sodium salts.

### Producing Syngenite

The potassium-enriched solids that have crystallised and remain in the evaporation pond after decantation of the Mg-rich supernatant liquor may be dissolved in water in situ to obtain a second concentrated liquor comprising greater than 40 g/L K and a relative Mg to K concentration (w/v) of less than or equal to 1:1. Alternatively, said solids may be dissolved in low total dissolved solids (TDS) (i.e., ≤35 g/l) brine or brackish groundwater. The volume of water or low TDS brine used to dissolve the solids will vary depending on the composition of the solids, and the temperature and climatic conditions. However, it will be appreciated that an excess volume of water may be used to dissolve the solids, and thus the resulting solution may need to undergo some evaporation, for example in the same or a further evaporation pond, to increase the concentration of the second concentrated liquor to greater than 40 g/L K.

The second concentrated liquor may comprise greater than 40 g/L K, greater than 45 g/L K, greater than 50 g/L K, or about 55 g/L K. In some embodiments, the second concentrated liquor comprises 40-55 g/L K.

The second concentrated liquor may comprise greater than 20 g/L Mg, greater than 25 g/L Mg, greater than 30 g/L Mg, greater than 40 g/L Mg, greater than 45 g/L Mg, or about 50 g/L Mg. The second concentrated liquor may comprise between 20 g/L Mg and 50 g/L Mg, between 25 g/L Mg and 50 g/L Mg, between 30 g/L Mg and 50 g/L Mg, between 40 g/L Mg and 50 g/L Mg, or between 45 g/L Mg and 50 g/L Mg.

Syngenite may be prepared by reacting the second concentrated liquor with gypsum. Although a stoichiometric or greater amount of gypsum may be added to the second concentrated liquor, the inventors have surprisingly found that less than a stoichiometric amount of gypsum may be used because a stoichiometric amount greater than 75% may not improve the potassium sulphate recovery.

The amount of gypsum added to the second concentrated liquor presents a compromise between potassium extraction and syngenite purity. For example, an increased stoichiometric amount of gypsum (i.e. a higher ratio of gypsum to second concentrated liquor) may increase potassium recovery slightly but also results in an increased amount of unreacted gypsum in the syngenite produced. The balance between potassium recovery and syngenite purity must be assessed depending on whether syngenite is planned to be produced as the end product for sale as a fertiliser.

The amount of gypsum added to the second concentrated liquor may vary between 70% and 90% of the stoichiometric amount.

Advantageously, the reacting step may be performed at lower temperatures than those used to produce syngenite in the prior art. For example, the reacting step may be performed at less than 40° C., less than 35° C., or at ambient temperature between 20° C. and 40° C. Reaction temperatures greater than 40° C. increasingly favour competing reactions that produce pentasalt or sodium syngenite.

The mixture may be reacted for a period sufficient to produce syngenite. It will be appreciated that the period will vary depending on the temperature and reaction conditions. The period may vary from 30 minutes to 48 hours, depending on various operating conditions. For example, the period may be more than 30 min, more than 60 min, more than 2 h, more than 4 h, more than 8 h, more than 16 h or more than 24 h.

The period may have duration between 30 min and 24 h, between 60 min and 12 h, between 60 min and 6 h, or between 90 minutes and 3 h.

In some embodiments, about a 75% stoichiometric amount of gypsum is mixed with the second concentrated liquor and the mixture may be agitated for about 2-4 h at a temperature of less than 40° C., in particular at a temperature of 25-35° C.

Syngenite precipitates from the reaction mixture, thereby leaving a potassium-depleted solution. Sodium and magnesium values remain in the potassium-depleted solution in an unreacted state as soluble cations.

The syngenite may be separated from the potassium-depleted solution by filtration, decantation, centrifugation and other conventional separation techniques as will be well understood by those skilled in the art. It will be appreciated that the separated syngenite may be washed one or more times, dried and packaged as a saleable fertiliser product. It will also be appreciated that in some embodiments it may be useful to introduce an amount of separated syngenite solids into the reaction mixture of the second concentrated liquor and gypsum to help seed syngenite precipitation.

The potassium-depleted solution may comprise greater than 20 g/L K or about 25 g/L K. The potassium-depleted solution may comprise greater than 20 g/L Mg, greater than 25 g/L Mg, greater than 30 g/L Mg, greater than 40 g/L Mg, greater than 45 g/L Mg, or about 50 g/L Mg.

The potassium-depleted solution may comprise between 20 g/L K and 28 g/L K, or between 20 g/L K and 25 g/L K. The potassium-depleted solution may comprise between 20 g/L Mg and 50 g/L Mg, between 25 g/L Mg and 50 g/L Mg, between 30 g/L Mg and 50 g/L Mg, between 40 g/L Mg and 50 g/L Mg, or between 45 g/L Mg and 50 g/L Mg.

In one particular embodiment, the potassium-depleted solution may comprise 23 g/L K and 47 g/L Mg.

In some embodiments, the separated potassium-depleted solution may be recycled and combined with the first concentrated liquor. For example, the separated potassium-depleted solution may be combined with the first concentrated liquor in a volumetric ratio of about 1:1. In this way, potassium that has not been recovered as syngenite in the first pass may be recycled to the first concentrated liquor so that it is not lost to waste.

### Leaching Syngenite

Although the syngenite produced by the process as described herein may be sold as a valuable fertilizer product in its own right, in some embodiments the syngenite may undergo a leaching step with water to produce gypsum and a potassium-enriched solution. The syngenite may be in the form of a wet filter cake having an entrained liquor in a range of 30-45 wt %. The wet syngenite may be mixed with water in a ratio of from about 1:3 to about 1:5 w/w, even about 1:4 w/w.

Syngenite may be leached for a period sufficient to dissolve potassium sulphate, leaving gypsum solids in the potassium-enriched solution. It will be appreciated that the period will vary depending on the temperature and reaction conditions. The period may vary from 30 minutes to 48 hours, depending on various operating conditions. For example, the period may be more than 30 min, more than 60 min, more than 2 h, more than 4 h, more than 8 h, more than 16 h or more than 24 h.

The period may have duration between 30 min and 24 h, between 60 min and 12 h, between 60 min and 6 h, between 2 h and 6 h, or between 3 h and 4 h.

Preferably, the leaching step is performed at a temperature less than 75° C., in particular in a range of 60° C. to 70° C.

In some embodiments, leaching the separated syngenite with water comprises contacting the syngenite with water at a temperature of 60° C. to 70° C. for about 4 h. The ratio of water to syngenite may be approximately 4 litres of water per kilogram of wet syngenite cake. Leaching syngenite under these conditions inhibits formation of pentasalt or sodium syngenite and produces a relatively pure gypsum product for recycle.

The gypsum may be separated from the potassium-enriched solution by filtration, decantation, centrifugation and other conventional separation techniques as will be well understood by those skilled in the art. It will be appreciated that the separated gypsum may be washed one or more times to recover entrained potassium sulphate. The gypsum may be recycled and mixed with the second concentrated liquor to prepare syngenite. In this way consumption of additional gypsum from external sources is minimised although it will be appreciated that there may be minor gypsum losses in the circuit over time.

The separated potassium sulphate-enriched solution comprises more than 20 g/L K₂SO₄, more than 30 g/L K₂SO₄, more than 40 g/L K₂SO₄, or more than 50 g/L K₂SO₄. In one embodiment the potassium sulphate-enriched solution comprises about 50 g/L potassium sulphate.

### Preparing Crystalline Potassium Sulphate

The separated potassium sulphate-enriched solution is then concentrated in one or more stages, for example in one or more evaporation ponds, to obtain a concentration of about 110 g/L potassium sulphate or saturation concentration.

Alternatively, the separated potassium sulphate-enriched solution may be concentrated by other well understood conventional techniques including evaporation to dryness and mechanical harvesting.

The concentrated potassium sulphate solution is then passed to a crystalliser, such as a vacuum crystalliser, to deposit potassium sulphate solids. As will be recognised by those skilled in the art, the potassium sulphate solids may undergo aging in the mother liquor to allow it to form more crystalline phases or to increase the particle size of the resulting potassium sulphate solids, thereby aiding solid-liquid separation and product saleability.

The crystallised potassium sulphate may be separated from the mother liquor by filtration, decantation, centrifugation and other conventional separation techniques as will be well understood by those skilled in the art. In one embodiment the separated crystallised potassium sulphate has a purity of >96%.

In another embodiment, a recovery yield of crystallised potassium sulphate with respect to the second concentrated liquor is greater than 75%, in particular greater than 80%.

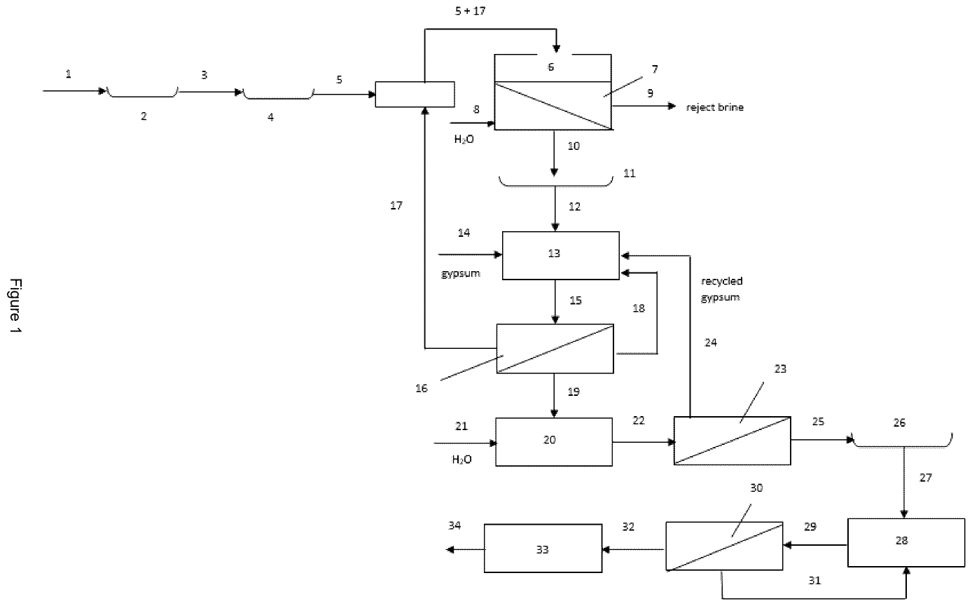

A method for recovering potassium sulphate in accordance with one embodiment will now be described with reference to the flowsheet shown in FIG. 1.

Partially evaporated brine (1) is fed to first evaporation pond (2). Halite is deposited and the remaining brine (3) comprising 10-12 g/L K and 32-39 g/L Mg is decanted and passed to the second evaporation pond (4). Further salts are deposited and the remaining concentrated brine (5) comprising about 30 g/L K and 90 g/L Mg is decanted and passed to a third evaporation pond (6) and crystalliser. The concentrated brine (5) is further evaporated in the third evaporation pond (6) until a Mg-rich supernatant brine analyses approximately 115 g/l Mg and potassium rich salts are crystallised.

The resulting crystallised potassium rich solids formed in the evaporation pond remain in situ and the Mg-rich supernatant is decanted or drained therefrom as a reject brine (9). The solids are redissolved in water (8) (or low TDS water) and the resulting solution (10) is passed to the fourth evaporation pond (11) where the solution of redissolved solids can be evaporated and a second concentrated liquor (12) comprising about 52 g/L K and 49 g/L Mg is produced.

Alternatively, the redissolved solids liquor may remain in the third evaporation pond (6) where said solution is evaporated to produce the second concentrated liquor as described in the preceding paragraph.

The second concentrated liquor (12) is passed to a first reactor (13) and mixed with gypsum (14) for 2-4 hours at a temperature in the range of 25-35° C. to produce a mixture of syngenite and a potassium-depleted solution comprising about 23 g/L K and 47 g/L Mg. Said mixture (15) is passed to a separator (16) and separated into syngenite (19) and the potassium-depleted solution (17). An amount of separated syngenite (18) may be recycled to the first reactor (13) to act as a seeding material for syngenite solids. The first reactor solids are washed with water during the separation step to remove salts entrained in the syngenite product.

The separated potassium-depleted solution plus wash liquor (17) from the first reactor (13) may be recycled and mixed with the concentrated brine (5). The process mass balance indicates that a volume ratio of about 1:1 for this step to provide optimum overall potassium recovery.

The separated wet syngenite (19) is passed to a second reactor (20) where it is leached with water (21) at a ratio of about 1:4 w/w for 4 hours at a temperature in the range of 60-70° C. The leach mixture (22) is passed to a separator (23) where gypsum solids (24) are separated from a potassium sulphate-enriched solution (25) comprising about 50 g/L potassium sulphate. The separated gypsum (24) may be recycled to the first reactor (13) for production of syngenite (15).

The potassium sulphate-enriched solution (25) is passed to a further evaporation pond (26) where said solution (25) is further concentrated to about 110 g/L potassium sulphate (or to saturation). The concentrated solution (27) is passed to a crystalliser (28) and a mixture (29) of the crystallised potassium sulphate solids (32) and the supernatant (31) are separated in separator (30). Alternatively, the potassium sulphate solution (25) may be directly evaporated in a vacuum crystalliser or similar to produce K₂SO₄ (not shown). The separated potassium sulphate solids (32) are subsequently dried in dryer (33) to produce dried K₂SO₄ product (34). The separated supernatant stream (31) may be recycled to the crystalliser (28). It will be appreciated that occasionally, as required, a small amount of supernatant stream (31) would be directed to waste via a liquor bleed steam to prevent cumulative impurities within the supernatant stream (31) from increasing beyond a predetermined concentration threshold.

The process described herein relates to the recovery of potassium sulphate from naturally occurring brine solutions (e.g. concentrated seawater) by addition of gypsum (CaSO₄·2H₂O) to such brines forming the insoluble double salt syngenite from which potassium sulphate is readily extracted by leaching with water.

Advantageously, the process described herein produces syngenite directly without the production of pentasalt. Potassium sulphate may be recovered from the syngenite by leaching with water, thereby providing a relatively pure gypsum product which can be recycled in the process. Moreover, the process described herein has improved potassium recovery from brine without the need to increase or augment the K content of the brine by addition of high value schoenite as described in U.S. Pat. No. 3,348,913.

### EXAMPLES

The following examples are to be understood as illustrative only. It should therefore not be construed as limiting the embodiments of the disclosure in any way.

Example 1. Three separate feed brines were prepared with the compositions shown in Table 1. The feed brines were reacted with a 75%, 100% and 150% stoichiometric amount of gypsum, respectively, at 30° C. for a period of 5 hours in a stirred reactor. The syngenite solids were subsequently filtered and the resulting filter cake was washed with water.

TABLE 1

| | K | Mg | Na | SO₄ | Cl | Vol. | gypsum | syngenite |
|---|---|---|---|---|---|---|---|---|
| | (mg/L) | (mg/L) | (mg/L) | (mg/L) | (mg/L) | (mL) | (g) | (g) |
| #1 | 49200 | 45000 | 28400 | 107600 | 144000 | 2000 | 165 | 471 |
| #2 | 50300 | 43300 | 28500 | 113000 | 135200 | 1500 | 165 | 417 |
| #3 | 50300 | 43300 | 28500 | 113000 | 135200 | 1500 | 248 | 505 |

The yield of syngenite was about 57% when the stoichiometric amount of gypsum added to the reactor was 75%. Surprisingly, the yield of syngenite did not materially increase with increasing stoichiometric amount of gypsum added to the reactor, staying between 57% and 58% yield for 100% and 150% stoichiometric addition of gypsum.

The overall recovery of potassium from the brines may be increased to above 75% by recycling the filtrate and combining it with the feed brine and concentrating the combined streams to produce a concentrated potassium liquor which is then subsequently reacted with a 75% stoichiometric amount of gypsum at 30° C. for a period of 2-5 hours and then subsequently filtering the resulting syngenite.

Example 2. Various brines having the compositions shown in Table 2 were prepared by evaporating respective feed brines to the saturation point of K, collecting the potassium-rich solids and redissolving said solids in water. The prepared brines were reacted with gypsum in a stirred reactor. The stoichiometric amount of gypsum, reaction period and temperature of each reaction are as indicated in Table 2. The syngenite solids were subsequently filtered and the resulting filter cake was washed with water. First pass recovery rates are also shown in Table 2.

The process described herein avoids mechanical harvesting of low grade potash salts. Such low grade salts require complex processing for potassium sulphate recovery. In the proposed process, the sodium and magnesium components in the feed brines to the syngenite reaction are efficiently rejected to the potassium-depleted solution, thereby reducing Na and Mg contamination of the final potassium sulphate product. Excess salts in the potassium depleted solution are eventually bled from the system via the reject stream (9). Alternatively, or additionally, the stream (17) may be diverted into the second evaporation pond (4), as required to prevent cumulative impurities from increasing beyond a predetermined threshold concentration.

TABLE 2

| | Brines | | | |
|---|---|---|---|---|
| | Seawater | Seawater | Lake | Lake |
| | bitterns | bitterns | Disappointment | Disappointment |
| | #60 | #65 | bitterns #42 | bitterns #29 |
| K | 52450 | 50750 | 50350 | 45600 |
| (mg/L) | | | | |
| Mg | 46950 | 45500 | 36900 | 43000 |
| (mg/L) | | | | |
| Na | 23300 | 38450 | 78500 | 82550 |
| (mg/L) | | | | |
| SO₄ | 113000 | 107700 | 120800 | 171200 |
| (mg/L) | | | | |
| Cl | 139600 | 161800 | 183900 | 181700 |
| (mg/L) | | | | |
| SG | 1.271 | 1.275 | 1.303 | 1.346 |
| Duration | 3 | 2 | 21.5 | 22 |
| (h) | | | | |
| Temp (°C) | 30 | 30 | 22 | 25 |
| Gypsum | 75 | 100 | 60 | 97 |
| stoich (%) | | | | |
| % K (first | 60 | 40 | 48 | 43 |
| pass) | | | | |
| recovery | | | | |

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

For example, some naturally occurring salt lake brines may inherently have a composition where K is greater than 40 g/L and which is low in Mg relative to K (e.g., about 1:1 or less). Brines having a composition where K is greater than 40 g/L may not need to be treated according to steps a)-c) as defined above.

Accordingly, in this particular aspect, there is provided a process for producing syngenite from an untreated brine comprising greater than 40 g/L K and about a 1:1 ratio of K to Mg, the process comprising reacting the untreated brine with a less than stoichiometric amount of gypsum at less than 40° C. to produce syngenite and a potassium-depleted solution, and separating syngenite from the potassium-depleted solution.

1. A process for producing syngenite from a brine, the process comprising the steps of:
a) concentrating said brine to obtain a first concentrated liquor having a K concentration approaching saturation and allowing the first concentrated liquor to further concentrate and separate as crystallised solids and a Mg-rich supernatant liquor;
b) decanting the Mg-rich supernatant liquor;
c) dissolving the crystallised solids in water to obtain a second concentrated liquor comprising greater than 40 g/L K and a relative Mg to K concentration (w/v) of less than or equal to 1:1; and
d) reacting the second concentrated liquor with less than a stoichiometric amount of gypsum at less than 40° C. to produce syngenite and a potassium-depleted solution, and separating syngenite from the potassium-depleted solution.

2. A process for recovering potassium sulphate from a brine, the process comprising the steps of:
a) concentrating said brine to obtain a first concentrated liquor having a K concentration approaching saturation and allowing the first concentrated liquor to further concentrate and separate as crystallised solids and a Mg-rich supernatant liquor;
b) decanting the Mg-rich supernatant liquor;
c) dissolving the crystallised solids in water to obtain a second concentrated liquor comprising greater than 40 g/L K and a relative Mg to K concentration (w/v) of less than or equal to 1:1;
d) reacting the second concentrated liquor with less than stoichiometric amount of gypsum at less than 40° C. to produce syngenite and a potassium-depleted solution, and separating syngenite from the potassium-depleted solution;
e) leaching the separated syngenite with water to produce gypsum and a potassium sulphate-enriched solution, and separating the gypsum from the potassium sulphate-enriched solution;
f) concentrating the potassium sulphate-enriched solution to a concentration sufficient for potassium sulphate to crystallise from said concentrated solution, and separating the crystallised potassium sulphate therefrom.

3. The process according to claim 2, wherein allowing the first concentrated liquor to separate into crystallised solids and Mg-rich supernatant liquor comprises transferring the first concentrated liquor to an evaporation pond and further evaporating the first concentrated liquor.

4. The process according to claim 2, wherein the Mg-rich supernatant liquor comprises >100 g/L Mg and <5-8 g/L K.

5. The process according to claim 2, wherein the Mg-rich supernatant liquor is decanted to waste leaving the crystallised solids in situ.

6. The process according to claim 2, wherein the crystallised solids are potassium-rich.

7. The process according to claim 2, wherein the process further comprises combining the separated potassium-depleted solution obtained in step d) with the brine in step a).

8. The process according to claim 7, wherein the ratio of K:Mg in the combined streams is about 1:2.5.

9. The process according to claim 2, further comprising recycling gypsum produced and separated in step e) for use in step d).

10. The process according to claim 2, wherein the ratio of K:Mg in the second concentrated liquor produced in step c) is about 1:1.

11. The process according to claim 2, wherein reacting the second concentrated liquor with gypsum comprises mixing the second concentrated liquor with about 75% to about 90% stoichiometric amount of gypsum.

12. The process according to claim 2, wherein leaching the separated syngenite with water comprises contacting the syngenite with water at a temperature of 60° C. to 70° C. for about 2-4 h.

13. The process according to claim 12, wherein the wet syngenite is mixed with water in a ratio of from about 1:3 to about 1:5 w/w.

14. The process according to claim 2, wherein the potassium sulphate-enriched solution comprises about 50 g/L potassium sulphate.

15. The process according to claim 2, wherein the separated crystallised potassium sulphate has a purity of >96%.

16. The process according to claim 2, wherein a yield of crystallised potassium sulphate with respect to the second concentrated liquor is greater than 75%.

17. A process for producing syngenite from an untreated brine comprising greater than 40 g/L K and about 1:1 K to Mg, the process comprising reacting the untreated brine with a less than stoichiometric amount of gypsum at less than 40° C. to produce syngenite and a potassium-depleted solution, and separating syngenite from the potassium-depleted solution.

18. The process according to claim 1, wherein allowing the first concentrated liquor to separate into crystallised solids and Mg-rich supernatant liquor comprises transferring the first concentrated liquor to an evaporation pond and further evaporating the first concentrated liquor.

19. The process according to claim 1, wherein the Mg-rich supernatant liquor comprises >100 g/L Mg and <5-8 g/L K.

20. The process according to claim 1, wherein the Mg-rich supernatant liquor is decanted to waste leaving the crystallised solids in situ.

21. The process according to claim 1, wherein the crystallised solids are potassium-rich.

22. The process according to claim 1, wherein the process further comprises combining the separated potassium-depleted solution obtained in step d) with the brine in step a).

23. The process according to claim 1, wherein the ratio of K:Mg in the second concentrated liquor produced in step c) is about 1:1.

24. The process according to claim 1, wherein reacting the second concentrated liquor with gypsum comprises mixing the second concentrated liquor with about 75% to about 90% stoichiometric amount of gypsum.
